(19) United States
(12) Patent Application Publication
(10) Pub. No.: US 2020/0138252 A1
(43) Pub. Date: May 7, 2020

(54) TOILET BRUSH WITH CLEANING SPRAY SYSTEMS

(71) Applicant: CRISTIAN LUCIAN CORNEA, CEDAR PARK, TX (US)

(72) Inventor: CRISTIAN LUCIAN CORNEA, CEDAR PARK, TX (US)

(21) Appl. No.: 16/733,330

(22) Filed: Jan. 3, 2020

Related U.S. Application Data
(60) Provisional application No. 62/792,402, filed on Jan. 15, 2019.

(51) Int. Cl. A47K 11/10; A46B 9/02; A46B 11/00; B08B 9/00

(52) U.S. Cl. CPC A47K 11/10; A46B 9/025; A46B 9/026; A46B 2200/304; A46B 11/0062; B08B 9/00; A46B 11/0055

(57) ABSTRACT

The present disclosure relates to a toilet brush with cleaning spray system. The toilet brush with cleaning spray system includes a brush head; a spray nozzle component, the brush head being attached to one end of the spray nozzle component; a rigid pipe, the other end of the spray nozzle component being attached to one end of the rigid pipe; and a cleaning spray system, the other end of the rigid pipe being attached to the cleaning spray system. The cleaning spray system is in communication with the spray nozzle component via the rigid aluminium pipe.

### TECHNICAL FIELD

The present disclosure relates to toilet brush technologies, and more particularly relates to toilet brush with cleaning spray systems.

### BACKGROUND

The common method of cleaning toilets is to use a disinfectant/detergent which is manually applied and then, if necessary, scrub with a toilet brush populated with bristles.

### SUMMARY

Accordingly, the present disclosure provides a toilet brush with cleaning spray system.

A toilet brush with cleaning spray system, which includes:

a detachable brush head;

a spray nozzle component, the brush head being attached to one end of the spray nozzle component;

a rigid pipe, the other end of the spray nozzle component being attached to one end of the rigid pipe; and

a cleaning spray system, the other end of the rigid pipe being attached to the cleaning spray system;

wherein the cleaning spray system is in communication with the spray nozzle component via the rigid pipe and reservoir.

### BRIEF DESCRIPTION OF THE DRAWINGS

FIG. 1 illustrates a schematic diagram of a toilet brush with cleaning spray system in accordance with an embodiment.

FIG. 2 illustrates an exploded schematic diagram of the toilet brush with cleaning spray system shown in FIG. 1.

FIG. 3 illustrates a schematic assembly diagram of the exploded toilet brush with cleaning spray system shown in FIG. 2.

FIG. 4 illustrates a schematic diagram of operating the toilet brush with cleaning spray system shown in FIG. 1.

### DETAILED DESCRIPTION OF THE EMBODIMENTS

In order to facilitate the understanding of the present disclosure, it will be described more fully hereinafter with reference to the accompanying drawings. Preferred embodiments of the present disclosure are shown in the drawings. However, the disclosure can be embodied in many different forms and is not limited to the embodiments described herein. Rather, these embodiments are provided so that the understanding of the disclosure of the present application will be more thorough and comprehensive.

It should be noted that when an element is referred to as being “fixed” to another element, it can be directly fixed on the other element or intervening element may be present. When an element is considered to be “connected” to another element, it can be directly connected to the other element or intervening element may be present. The terms “vertical” “horizontal” “left,” “right,” and the like, as used herein, are for illustrative purposes only.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Unless otherwise defined, all terms (including technical and scientific terms) used herein have the same meaning as commonly understood by one of ordinary skill in the art to which this invention belongs. The terms used in the specification herein are only for the purpose of describing specific embodiments and are not intended to limit the present disclosure. The term “and/or” used herein includes any and all combinations of one or more of the associated listed items.

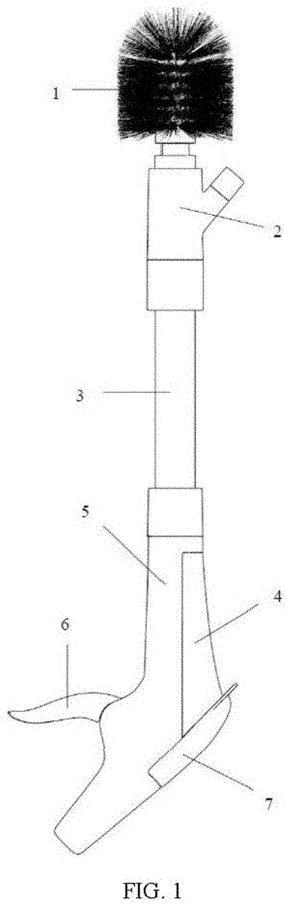

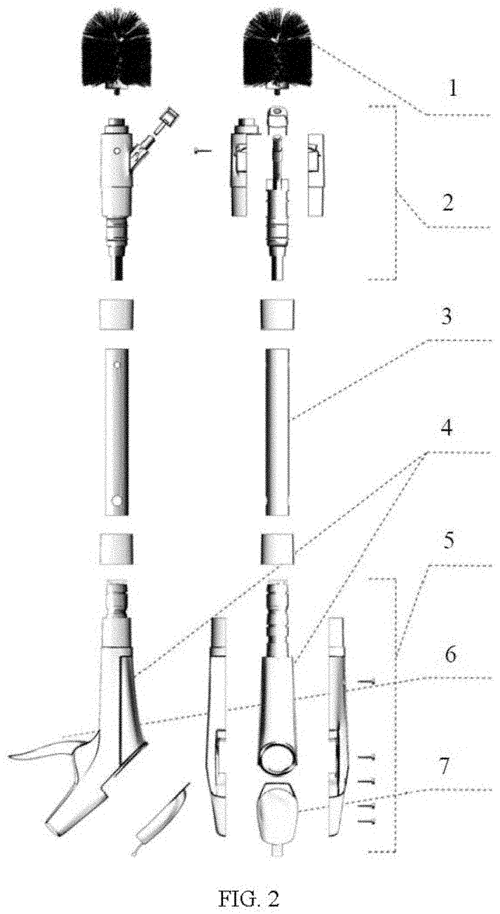

As shown in FIG. 1 and FIG. 2, a toilet brush with cleaning spray system is provided according to an embodiment, which is, for example, used for scrubbing tough stains and follows the toilet contour, reaching under the rim with ease.

In an embodiment, the toilet brush with cleaning spray system includes a brush head 1, a spray nozzle component 2, a rigid pipe 3 and a cleaning spray system. In an embodiment, the cleaning spray system has a convenient reservoir configured to receive a cleaning solution. Further, the cleaning spray system can be triggered by hand. Accordingly, cleaning solution is applied directly to hard-to-reach spots. No separate cleaning supplies or gloves are required, simply spraying and scrubbing quickly and easily.

In an embodiment, the brush head 1 is attached to one end of the spray nozzle component 2, the other end of the spray nozzle component 2 is attached to one end of the rigid pipe 3, and the other end of the rigid pipe 3 is attached to the cleaning spray system.

In an embodiment, the brush head 1 is detachablely connected to one end of the spray nozzle component 2, the other end of the spray nozzle component 2 is detachablely connected to one end of the rigid pipe 3, and the other end of the rigid pipe 3 is detachablely connected to the cleaning spray system.

In an embodiment, the cleaning spray system is in communication with the spray nozzle component 2 via the rigid pipe 3. In such a configuration, the cleaning solution can be injected into the cleaning spray system. When the cleaning spray system is triggered by hand, the cleaning solution is driven to flow from the cleaning spray system via the rigid pipe 3 to the spray nozzle component 2, and then is sprayed from the spray nozzle component 2 at around 60 degree horizontal wide, so that spray once around the rim and easily scrub the toilet bowl (amount of detergent dispersed 1.4-1.8 cc for one spray).

In an embodiment, the cleaning spray system includes a piston based spraying component 5, a detergent tank 4, a cap 7 and a flap actuator component 6. In an embodiment, the detergent tank is arranged inside the piston based spraying component 5. In an embodiment, as shown in FIG. 2, the detergent tank 4 is surrounded by the housing of the piston based spraying component 5. The detergent tank 4 has a detergent inlet thereon. In an embodiment, the detergent inlet is in communication with the external. In other words, the detergent inlet is configured to guide a detergent solution into the detergent tank. In an embodiment, the detergent solution can be a powerful and concentrate, but environmentally friendly, lilac-scented cleaning solution that both freshens and sanitizes the toilet with one single spray.

In an embodiment, the cap 7 is configured to open or close the detergent inlet. When the detergent inlet is opened by the cap 7, the external detergent solution can be simple injected into the detergent tank 4. When the detergent inlet is closed by the cap 7, the toilet brush with cleaning spray system can be used to clean the toilet.

In an embodiment, the cap 7 is provided with a rubber gasket, effectively preventing the detergent solution from leakage.

In an embodiment, the brush head 1 is provided with stiff bristled brushes, so as to scrub tough stains, with a heavy duty, stiff bristled brush, engineered to reach the tough contours of the toilet bowl.

In an embodiment, the flap actuator component 6 is configured to actuate the piston based spraying component 5, so that the piston based spraying component 5 can drive the detergent solution to spray from the spray nozzle component 2 via the rigid pipe 3. In an embodiment, the flap actuator component 6 can be triggered by hand, and the flap actuator component 6 actuates the piston based spraying component 5. Accordingly, used daily the toilet brush with cleaning spray system can clean better while saving cleaning products, saves water and time and pollutes less.

In an embodiment, the brush head 1 is provided with stiff bristled brushes. In an embodiment, the rigid pipe 3 is a plastic or metal pipe. In an example, the rigid pipe 3 is an aluminum pipe.

In an embodiment, the toilet brush with cleaning spray system has the sprinkler and detergent reservoir for cleaning, disinfecting and perfuming with only one application, and is designed for efficiently cleaning under the bowl rim. In an embodiment, the toilet brush with cleaning spray system has the following sizes: Dimension: 3.9×3.9×19.6 inches; Weight: 0.58 pound (empty).

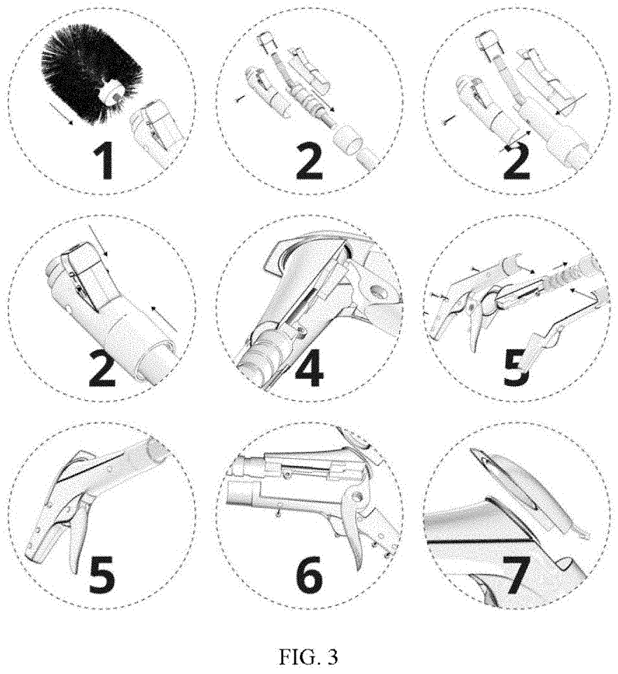

In an embodiment, the brush head 1, the spray nozzle component 2, the rigid pipe 3, the detergent tank 4, the piston based spraying component 5, the flap actuator component 6 and the cap 7 can be assembled as shown in FIG. 3. All parts work seamlessly and are easy to handle and to replace.

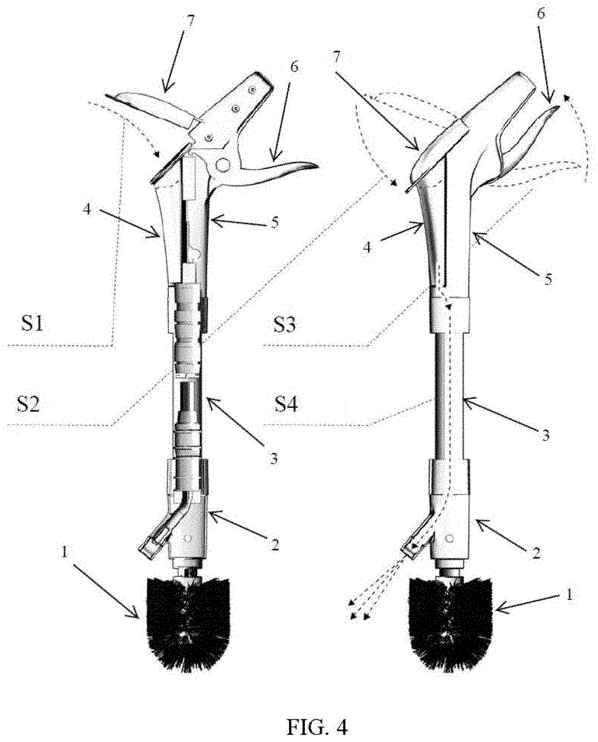

As shown in FIG. 4, when the toilet brush with cleaning spray system is operated, four steps are performed.

At step S1, the cap 7 is opened, and the detergent solution is guided into the detergent tank 4 via the detergent inlet.

At step S2, the cap 7 is closed, and then the detergent solution is sealed in the detergent tank 4.

At step S3, the flap actuator component 6 is pressed by hand, the piston based spraying component 5 is actuated by the flap actuator component 6, the piston based spraying component 5 compresses the interior cavity of the detergent tank 4, and then the detergent solution in the interior cavity of the detergent tank 4 is driven to flow from the detergent tank 4 to the spray nozzle component 2 via the rigid pipe 3, so as to spray from the spray nozzle component 2, as shown by arrows in FIG. 4.

The technical features of the above-described embodiments can be combined arbitrarily. For the sake of brevity of description, all possible combinations of the technical features in the above embodiments are not described. However, as long as there is no contradiction between the combinations of these technical features, all the combinations should be considered as the scope of this disclosure.

The above-mentioned embodiments are merely illustrative of several embodiments of the present disclosure, and the description thereof is more specific and detailed, but is not intended to limit the scope of the present disclosure. It should be noted that a number of variations and modifications can be made by those skilled in the art without departing from the spirit and scope of the present disclosure. Therefore, the scope of the present disclosure should be determined by the appended claims.

What is claimed is:

1. A toilet brush with cleaning spray system, comprising:
a brush head;
a spray nozzle component, the brush head being detachablely attached to one end of the spray nozzle component;
a rigid pipe, the other end of the spray nozzle component being attached to one end of the rigid pipe; and
a cleaning spray system, the other end of the rigid pipe being attached to the cleaning spray system;
wherein the cleaning spray system is in communication with the spray nozzle component via the rigid pipe.

2. The toilet brush with cleaning spray system according to claim 1, wherein the cleaning spray system comprises:
a piston based spraying component;
a detergent tank as a reservoir to be arranged inside the piston based spraying component and having a detergent inlet thereon; wherein the detergent inlet is configured to guide a detergent solution into the detergent tank;
a cap configured to open or close the detergent inlet; and
a flap actuator component configured to actuate the piston based spraying component, so that the piston based spraying component can drive the detergent solution to spray from the spray nozzle component via the rigid pipe.

3. The toilet brush with cleaning spray system according to claim 2, wherein the cap is provided with a rubber gasket.

4. The toilet brush with cleaning spray system according to claim 1, wherein the brush head is provided with stiff bristled brushes.

5. The toilet brush with cleaning spray system according to claim 1, wherein the rigid pipe is a plastic or metal pipe.

6. The toilet brush with cleaning spray system according to claim 1, wherein the rigid pipe is an aluminum pipe.
